(19) United States
(12) Patent Application Publication
(10) Pub. No.: US 2003/0187686 A1
(43) Pub. Date: Oct. 2, 2003

(54) Shipped product allocating system, method and program therefor

(75) Inventor: Toshihiro Michishita, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/401,402

(22) Filed: Mar. 28, 2003

(30) Foreign Application Priority Data
Mar. 29, 2002 (JP) 2002-095912

(51) Int. Cl. G06F 17/60

(52) U.S. Cl. 705/1

(57) ABSTRACT

A system, a method and a program for allocating shipped products are disclosed, in which the products to be shipped to a given customer from which an order has already been accepted are delivered without being delayed behind another order received later thereby to maintain the customer service. The state of a plurality of demand information and order information for shipped products are input (step S1), these information are sorted into a plurality of allocation groups (step S2), shipped products in a predetermined group are sorted in order of receiving the demand information or the order information (step S3), the shipped products belonging to a given group are allocated in a predetermined order of priority (step S4), and the shipped products are reallocated in order of receiving the demand information or the order information (step S5).

### BACKGROUND OF THE INVENTION

1. Field of the Invention

The present invention relates to a shipped product allocating system, a method and a program therefor, wherein the shipped products are ordered to be shipped on the delivery date desired by each customer, based on products in stock and products to be delivered from factories.

2. Description of the Related Art

In the conventional method of allocating products to be shipped, the order information is arranged in the order of a specific limited event such as the generation of the order information or the delivery date desired by each customer, and products in stock and products to be delivered from factories are allocated for ordered products to be shipped, accordingly.

In the above conventional method, if the number of products ordered to be shipped is greater than that of products previously desired, if the order information is arranged in order of a specific limited event such as the generation of the order information or the delivery date desired by each customer, the products may not be allocated to customers previously ordered, but may be allocated to customers ordered afterward, thus leading to a deteriorated customer service.

### SUMMARY OF THE INVENTION

This invention is intended to obviate these problems, and the object thereof is to provide a shipped product allocating system, a method and a program therefor, and therefore the object of the present invention is to eliminate the allocation in the order of a specific limited event such as the chronological order of the order information generation or the delivery time as in the prior art and, at the same time, to realize an allocation meeting customer demand for a last-minute order change or an order addition, which allocates products to customers such that first ordered customer can be served first, in case the number of products ordered to be shipped is greater than that of products previously desired, thus maintaining a high-quality customer service.

In order to achieve this object, according to the invention, there is provided a shipped product allocating system, wherein the shipped products are ordered to be shipped on the delivery date desired by each customer, based on products in stock and products to be delivered from factories, in which the shipped product allocation system comprises:

means for inputting the state of a plurality of demand information and a plurality of order information on shipped products;

means for classifying the information into a plurality of allocation groups;

means for sorting a predetermined one of the groups in order of receiving the demand information or the order information;

means for allocating the shipped products belonging to a given group in a predetermined order of priority; and

means for reallocating the shipped products in order of receiving the demand information or the order information.

In the shipped product allocation system, the plurality of the groups include at least an in-shipment group, at least a delivery time confirmed group and at least a delivery time unconfirmed group.

In the shipped product allocation system, the shipped products belonging to a given group are allocated in order of selected one of delivery time and quantity.

According to the shipped product allocation system, the allocation of shipped products for orders exceeding a predetermined quantity presented beforehand is managed based on order date information including hour, minute and second information, that is managed on first-come-first-served basis and, thus, the allocation for a customer from whom an order is received earlier can be prevented from being delayed behind the allocation for another customer from whom an order is received later.

### BRIEF DESCRIPTION OF THE DRAWINGS

FIG. 1 is a schematic diagram showing a constitution of a shipped product allocation system according to one aspect of the present invention.

FIG. 2 is a flowchart for the whole process for explaining the operation according to the invention.

FIG. 3 is a flowchart for classifying the demand information into a plurality of allocation groups according to the invention.

FIG. 4 is a flowchart for classifying the order information into a plurality of allocation groups according to the invention.

FIGS. 5, 5A and 5B are diagrams showing the pre-allocation process for classifying the initial order/demand information into groups.

FIGS. 6, 6A and 6B are diagrams showing the result of sorting by the ordered date only for the group C after the pre-allocation process of grouping of FIG. 5.

FIGS. 7, 7A and 7B are diagrams showing the allocation process for allocating shipped products based on the sorting result shown in FIG. 6 and the allocation source.

FIG. 8 is a diagram showing the allocation process of FIG. 7 in detail.

FIGS. 9 and 9A to 9D are diagrams showing the pre-allocation process in which the order/demand information input after the preceding allocation process shown in FIG. 7 are classified by group based on the preceding allocation result shown in FIG. 7 and the order/demand addition/change information.

FIGS. 10 and 10A to 10D are diagrams showing the result of the sorting process carried out according to the order received date only for the group C after the pre-allocation process in the groupwise classification shown in FIG. 9.

FIG. 11 is a flowchart for the pre-allocation process.

FIG. 12 is a flowchart for the first allocation process for group A.

FIG. 13 is a flowchart for the first allocation process for group B.

FIG. 14 is a flowchart for the first allocation process for group C.

FIG. 15 is a flowchart for the second allocation (reallocation) process for group C.

### DESCRIPTION OF THE PREFERRED EMBODIMENTS

Embodiments of the invention and the operation thereof will be described in detail, below, and one by one, with reference to the accompanying drawings.

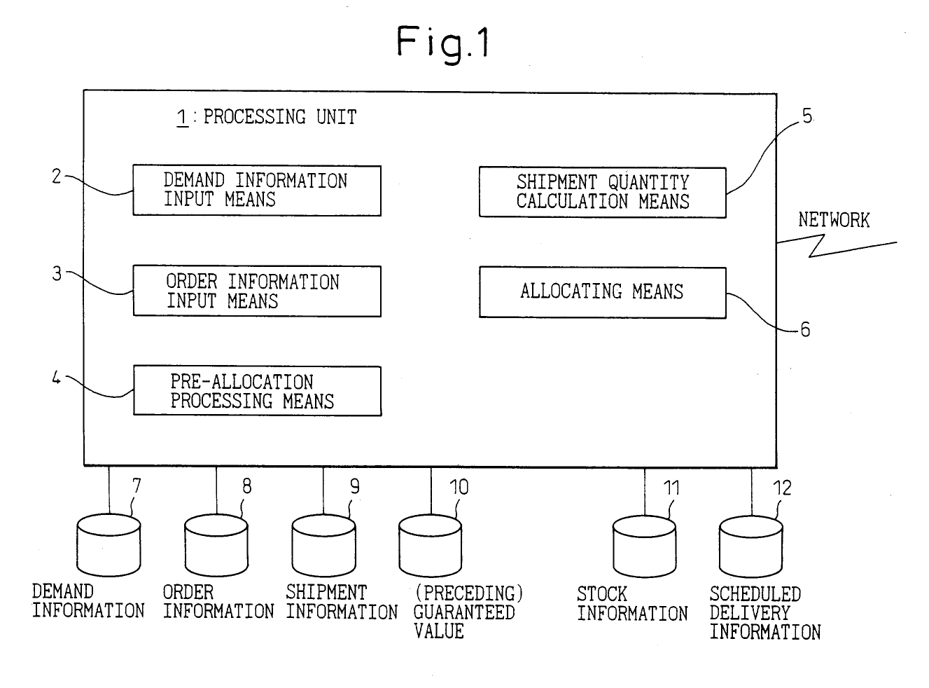

FIG. 1 is a diagram showing a schematic diagram showing a constitution of a shipped product allocation system according to one aspect of the present invention.

In FIG. 1, a shipped product allocation system is shown as a whole and comprises a processing unit 1 that classifies the demand information, which is temporal order information, and the order information, which is formal order information, into a plurality of groups followed by the allocation in each group in accordance with a program, and after the allocation, reallocates them based on the order date desired by each customer. The processing unit 1, constructed by a computer system having at least a CPU and a memory, includes demand information input means 2, order information input means 3, pre-allocation processing means 4, shipment quantity calculation means 5 and allocating means 6.

The demand information input means 2 is for inputting the demand information of a given customer (the demanded weekly amount of an item, for example), and is supplied with (retrieves), as an example, the customer demand information input and transmitted thereto by way of a terminal, a distributor or an agent through a network.

The order information input means 3, on the other hand, is for inputting the formal order information (which includes order date information) of a customer, and is supplied with (retrieves), as an example, the formal order information of the customer input and transmitted thereto by a terminal of a distributor or an agent through a network.

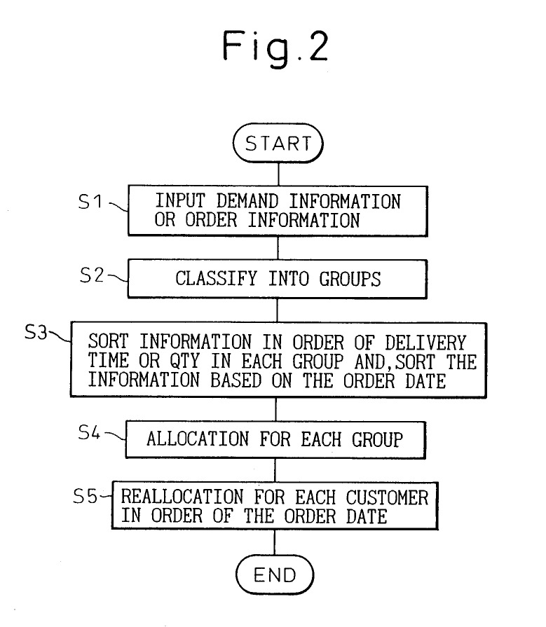

The pre-allocation processing means 4 classifies the input demand information and the input order information into a given one of the groups (as will be described again with reference to FIGS. 2 to 4) for allocation.

The shipment quantity calculation means 5 is for calculating the shipment quantity based on the demand information and the order information.

The allocating means 6 is for allocating the shipped products first in a group, and then reallocating them based on the order date desired by each customer (as will be described later with reference to FIGS. 2 and 5 to 11).

The allocation system also comprises an external storing unit 13, which stores a demand information file 7, an order information file 8, a shipment information file 9, a guaranteed value (preceding allocation) file 10, a stock information file 11, a scheduled delivery information file 12 and the like.

A demand information file 7 is for storing the demand information by customer or, for example, the predicted demanded quantity of a given item for the week for each customer.

An order information file 8 is for storing the formal order information from the customer.

A shipment information file 9 is for storing the shipment information (shipment quantity of each item, for example) calculated based on data stored in the demand information file 7 and the order information file 8.

A guaranteed value (preceding allocation) file 10 is for storing the preceding allocation (preceding guaranteed value) allocated for order information of the customer stored in the demand information file 7.

A stock information file 11 is for storing the stock information for each item.

A scheduled delivery information file 12 is for storing the information on the scheduled delivery of an item produced in a production system such as factories.

Now, the whole operation of the processing unit 1 will be explained with reference to the flowchart of FIG. 2.

FIG. 2 is a flowchart for the whole process for explaining the operation according to the invention.

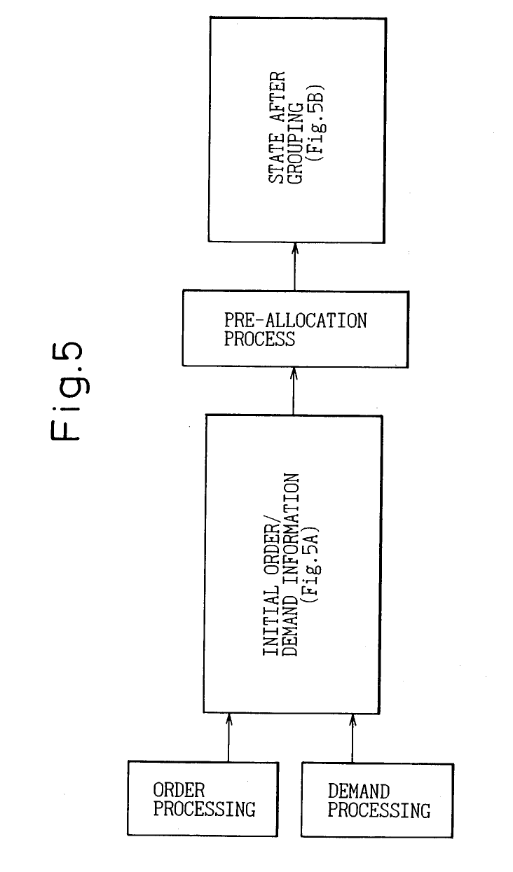

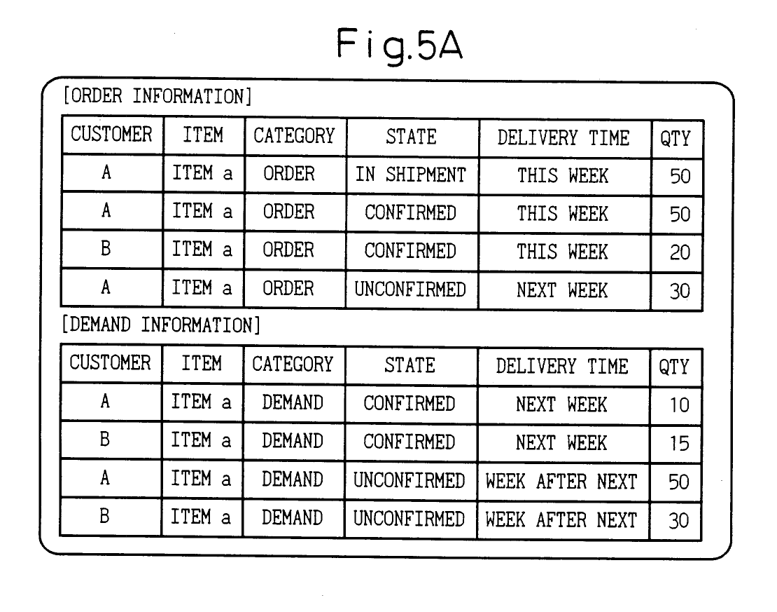

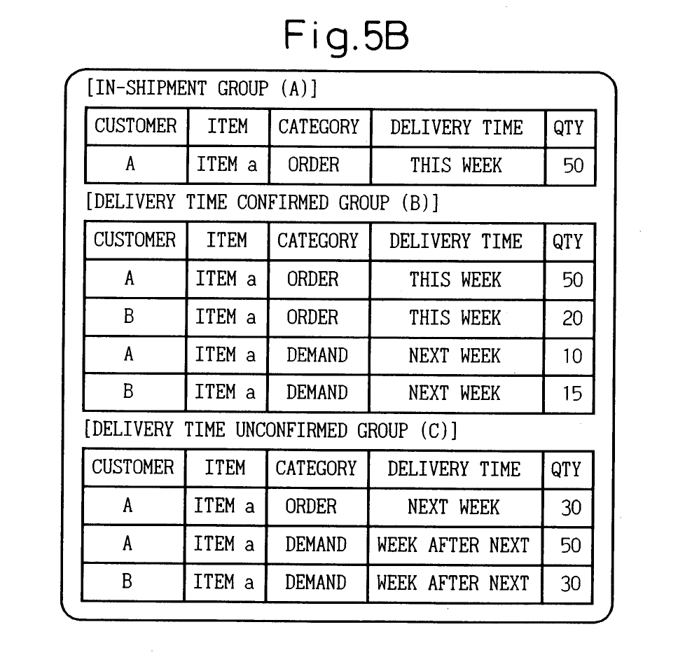

In FIG. 2, the demand information and the order information are input in step S1. Specifically, the demand information 7 and the formal order information of the customer are input (retrieved) through the demand information input means 2 and the order information input means 3 shown in FIG. 1. The demand information and the order information shown on left side in FIG. 5, namely in FIG. 5A and described later are also input (retrieved).

In step S2, the information are classified by group. In this process, the demand information and the order information input in step S1 are sorted (classified) into any of three groups including an in-shipment group A, a confirmed group B and an unconfirmed group C, for example, as shown on right side in FIG. 5, namely in FIG. 5B.

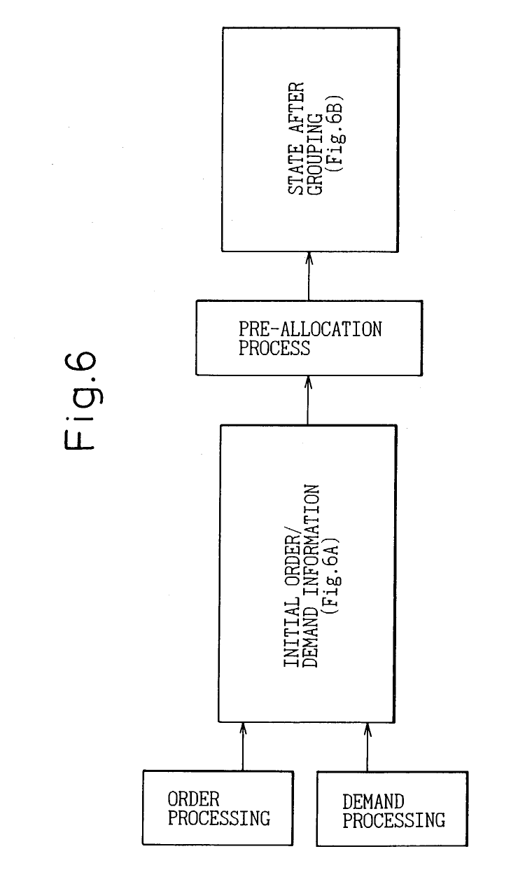

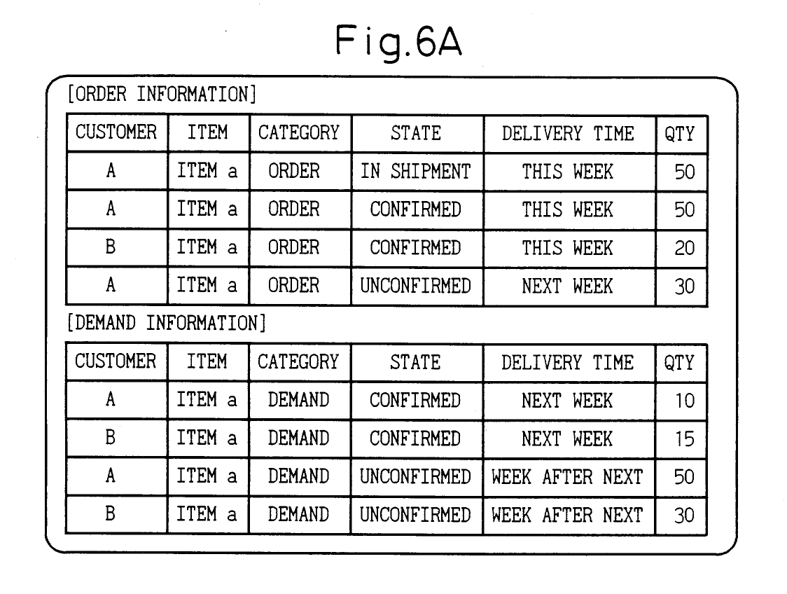

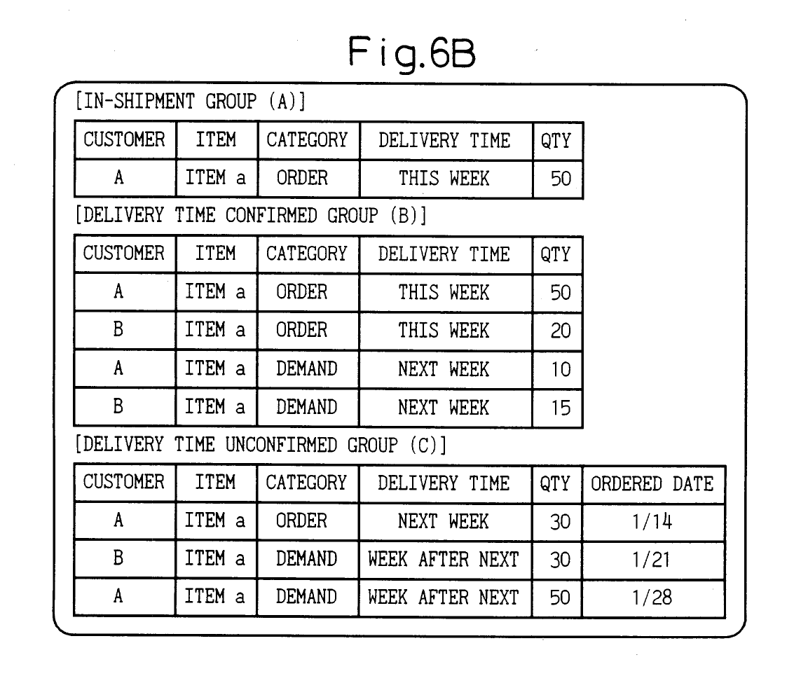

In step S3, the information are sorted in each group in order of delivery time and quantity. Specifically, as shown in FIG. 5B and described later, for example, the information, after being classified into the in-shipment group A, the confirmed group B and the unconfirmed group C in step S2, is sorted in order of delivery time. If the delivery time and the order date are the same, the information is additionally stored in ascending order of quantity. This is because the allocation based on an ascending order of quantity is more successful than other allocations. Next, the information is sorted based on the order date, as shown in FIG. 6.

In step S4, the shipped products are allocated in each group. Specifically, the information, which has been sorted in order of delivery time or in the ascending order of quantity in step S3 in each group, is sorted for allocating the original stock information in each group. Here, the original stock means the stock of ensured products for the shipment.

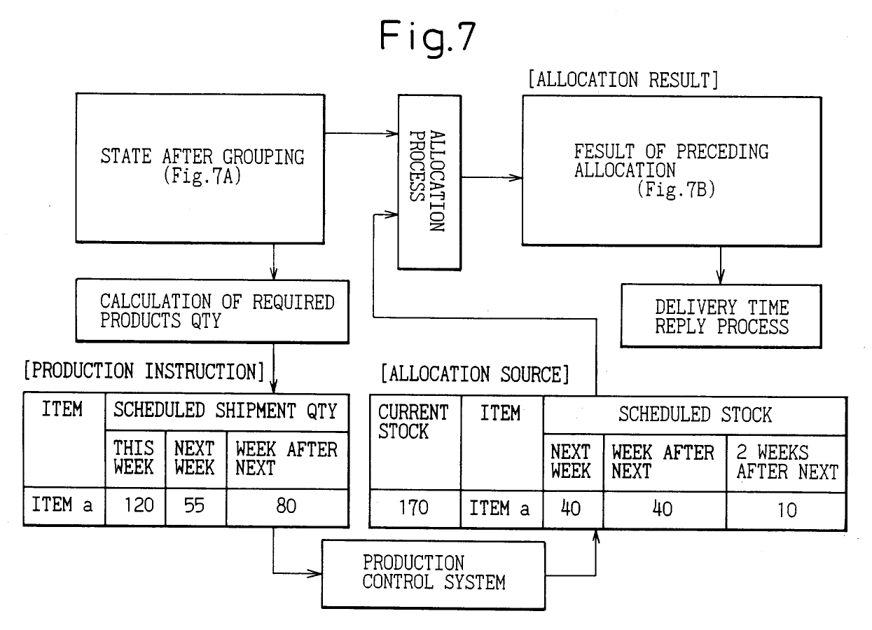

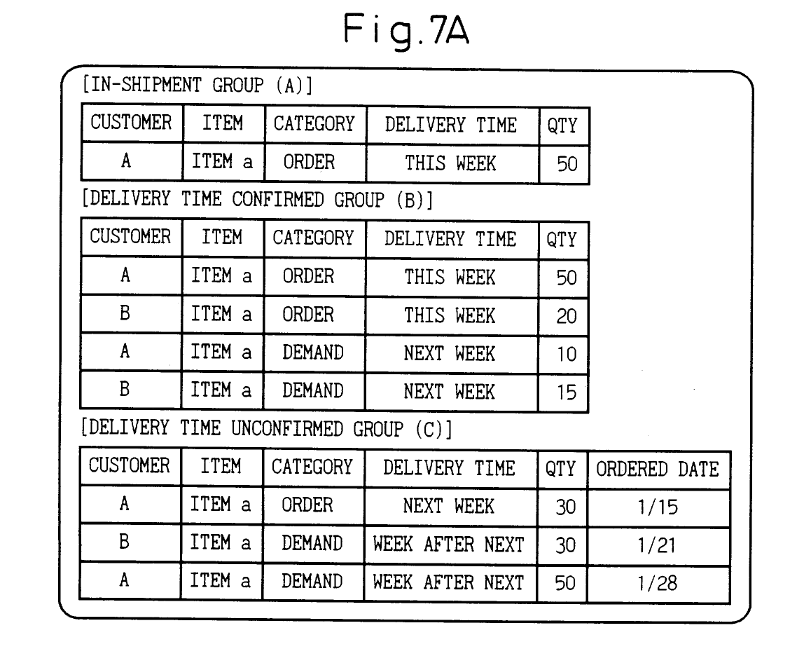

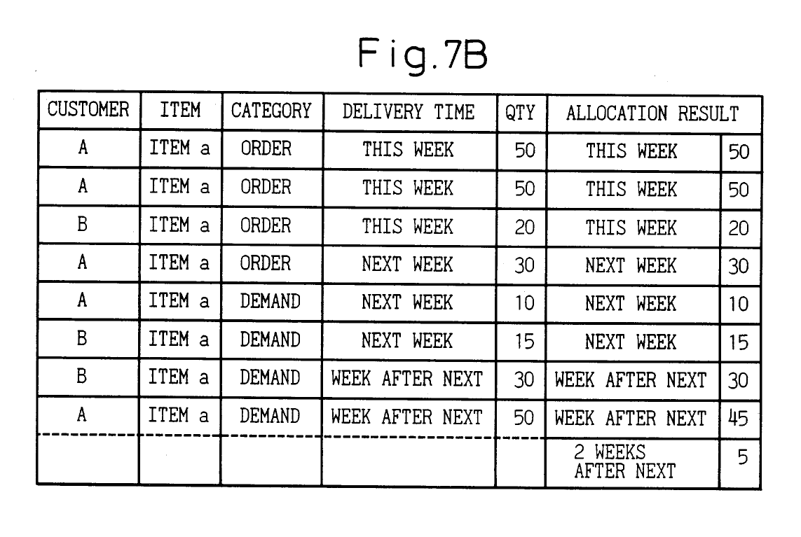

In step S5, the information is reallocated for each customer. Specifically, after the shipped products are allocated for each group in step S4, the allocation for the customers are retrieved from all the groups, and reallocated, for example, by sorting the shipped products for each customer in order of the order date including hour, minute and second information (see FIGS. 6 and 7 as described later).

As described above, the demand information and the order information of the customers are classified into groups (groups A, B and C, for example) and the shipped products are allocated in each group (in order of delivery time and in the ascending order of quantity, for example), after which the shipped products are reallocated for each customer based on the order date. In this way, the allocation in order of a specific limited event such as the generation of the order information or the delivery time as in the prior art is eliminated, while at the same time the allocation for a customer from whom an order is received earlier can be prevented from being delayed behind the allocation for another customer from whom an order is received later. Explanations of the classification will be made, below, one by one.

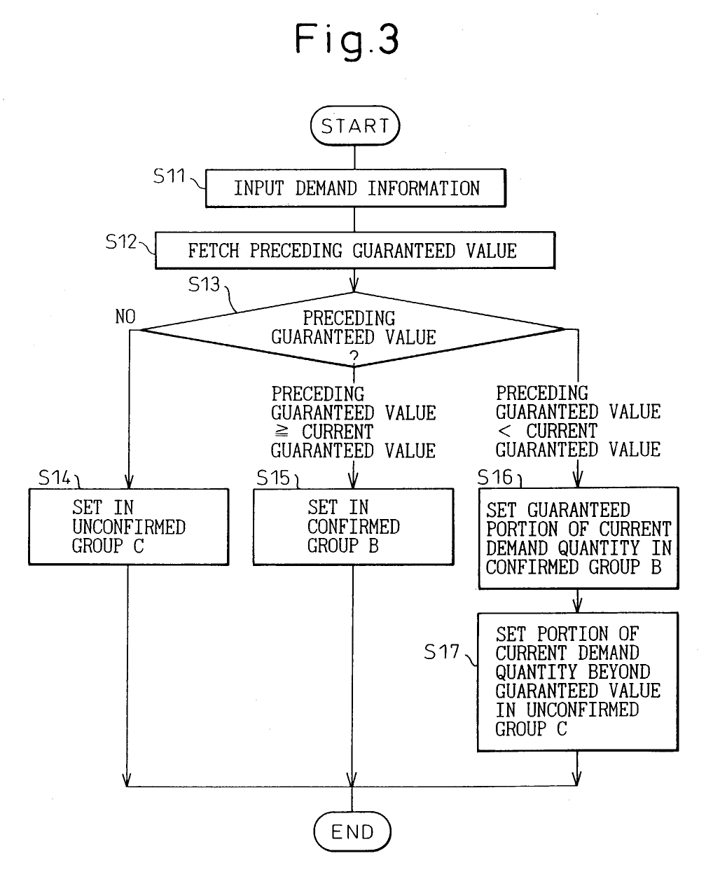

FIG. 3 is a flowchart for classifying the demand information into a plurality of allocation groups according to the invention.

In FIG. 3, the demand information is input in step S11. In step S12, the preceding guaranteed value is retrieved. Here, the guaranteed value means the demanded quantity ensured after the preceding allocation.

In step S13, one of the following states is selectively determined:

No preceding guaranteed value

Preceding guaranteed value≧current demanded quantity

Preceding guaranteed value<current demanded quantity

In the absence of the preceding guaranteed value, it is determined that the particular information is the unconfirmed demand information lacking the preceding guaranteed value, and therefore the process proceeds to step S14, where the information is sorted (classified) as an unconfirmed group.

In the case where it is determined in step S13 that the preceding guaranteed value is not smaller than the current demanded quantity (i.e. it is determined that the preceding guaranteed value is confirmed and smaller than the current demanded quantity), on the other hand, the process proceeds to step S15 in which the portion of the current demanded quantity corresponding to the guaranteed value is classified as the confirmed group B, and the process proceeds to step S17.

In step S17, the portion of the current demanded quantity exceeding the guaranteed value is classified as the unconfirmed group C. A given demanded quantity, if larger than the preceding guaranteed value, is sorted into two groups (the confirmed group B and the unconfirmed group C) in steps S16 and 17 for allocation in each of the groups. The shipped products are thus reallocated for each customer based on the order date. In this way, the allocation in order of a specific limited event such as the generation of the order information or the delivery time as in the prior art is eliminated, while at the same time the allocation for a customer from whom an order is received earlier can be prevented from being delayed behind the allocation for another customer from whom an order is received later.

As described above, the demand information of the customers can be classified into the unconfirmed group C (steps S14 and S17) and the confirmed group B (steps S15 and S16) in each of the cases where there is no guaranteed value, the demanded quantity is smaller than the preceding guaranteed value and the demanded quantity exceeds the preceding guaranteed value.

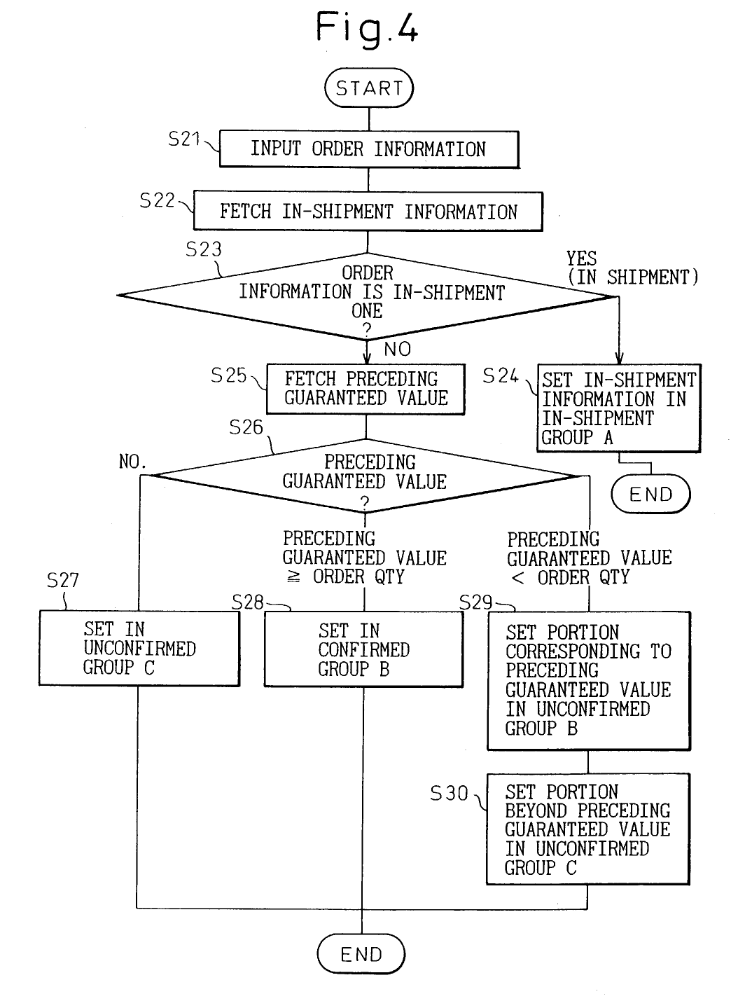

FIG. 4 is a flowchart for classifying the order information into a plurality of allocation groups according to the invention.

In FIG. 4, the order information is input in step S21. In step S22, the in-shipment information is retrieved.

In step S23, it is determined whether the product covered by the particular order information is in shipment or not. In the case where the answer is YES, it is determined that the ordered product is in shipment, and therefore the order information is classified as the in-shipment group A in step S24. In the case where the answer is NO, on the other hand, the process proceeds to step S25.

In step S25, the preceding guaranteed value is fetched. In step S26, one of the following states is selectively determined:

No preceding guaranteed value

Preceding guaranteed value≧current demanded quantity

Preceding guaranteed value<current demanded quantity

In the case where it is determined in step S26 that there is no preceding guaranteed value (i.e. the particular order information is not accompanied by any preceding guaranteed value and is determined as the unconfirmed order information), the process proceeds to step S27, where the particular order information is classified as the unconfirmed group C.

In the case where it is determined in step S26 that the preceding guaranteed value is larger than the quantity in the current order information (i.e. it is determined that the preceding guaranteed value is confirmed and equal to or larger than the quantity in the current order information), then the process proceeds to step S28 and the particular order information is classified as the confirmed group B.

In the case where it is determined in step S26 that the preceding guaranteed value is smaller than the quantity in the current order information (i.e. it is determined that the preceding guaranteed value is confirmed and smaller than the quantity in the current order information), the process proceeds to step S29 and the portion of the current order information corresponding to the guaranteed value is classified as the confirmed group B, followed by proceeding to step S30.

In step S30, the portion of the current order information that exceeds the guaranteed value is classified as the unconfirmed group C. A given piece of order information, if larger than the preceding guaranteed value, is classified into two groups (the confirmed group B and the unconfirmed group C) and the shipped products are allocated respectively in steps S29 and 30. The shipped products are thus reallocated for each customer based on the order date. In this way, the allocation in order of a specific limited event such as the generation of the order information or the delivery time as in the prior art is eliminated, while at the same time the allocation for a customer from whom an order is received earlier can be prevented from being delayed behind the allocation for another customer from whom an order is received later.

As described above, the formal order information of the customer can be classified into the in-shipment group A (step S27), the unconfirmed group C (step S28), the confirmed group B (step S29) and the unconfirmed group C (step S30) in the cases where the ordered products are in shipment, there is no preceding guaranteed value, the order information is less than the preceding guaranteed value and the order information exceeds the preceding guaranteed value, respectively.

FIGS. 5, 5A and 5B are diagrams showing the pre-allocation process for classifying the initial order/demand information into groups. As shown on the left side of FIG. 5, namely in FIG. 5A, the order/demand information are registered in the following corresponding categories by the order/demand process:

Customer name:

Item:

Type: Order or demand

State: In shipment, confirmed, unconfirmed

Delivery time: This week, next week, week after next, etc.

Quantity:

As shown on the right side of FIG. 5, namely in FIG. 5B, the pre-allocation process is for classifying the order/demand information into groups A, B and C in accordance with the state (in shipment, confirmed, unconfirmed respectively).

For example, data as shown on line 1 in the order information is an “in shipment” state, thus the information is classified into the in-shipment group A; data as shown on lines 2 and 3 in the order information are “confirmed” states, thus the information are classified into the confirmed group B; and data as shown on line 4 in the order information is an “unconfirmed” state, thus the information is classified into the unconfirmed group C.

FIGS. 6, 6A and 6B are diagrams showing the result of sorting by the ordered date only for the group C after the pre-allocation process of grouping of FIG. 5.

The other parts in FIG. 6, 6A and 6B are the same as those of FIGS. 5, 5A and 5B. Furthermore, in the pre-allocation process as shown in FIGS. 6, 6A and 6B, as explained before, if the delivery time and the order date are the same, the information is sorted in the ascending order of quantity.

FIGS. 7, 7A and 7B are diagrams showing the allocation process for allocating shipped products based on the sorting result shown in FIG. 6 and the allocation source. The allocation process shown in FIG. 7 represents the case lacking the preceding allocation result. As seen from the allocation result, the allocation is carried out in accordance with the ordered date. The allocation result shown on the right side of FIG. 7 namely in FIG. 7B is registered with the following corresponding information.

Customer name:

Item:

Type: Order or demand

Delivery time: This week, next week, week after next, etc.

Quantity:

Allocation result: 50 for this week, etc.

The lower left part of FIG. 7 shows the production instruction. Scheduled shipment quantities for this week, next week and the week after next are calculated based on delivery time and quantities obtained from the sorting result in the pre-allocation process as shown in the upper left of FIG. 7, namely FIG. 7A.

The allocation source table is shown in the central lower part of FIG. 7.

The allocation source table indicates scheduled stock in the near future which is obtained by arranging the quantity of production of the product to be shipped based on the quantity of current stock and the demand information.

The right part of FIG. 7, namely FIG. 7B shows the allocation result after allocation by group.

FIG. 7B shows an allocated result after sorting based on the types and the delivery time (For the unconfirmed group, sorting may be additionally executed in order of delivery time as previously explained). Herein, five quantities are allocated for two weeks after next week since the allocation quantity of a week after next week is short.

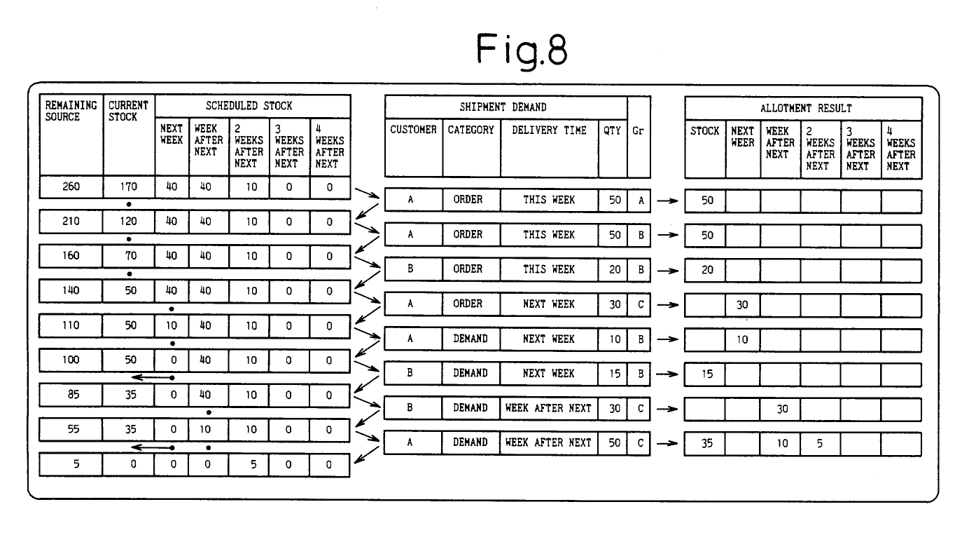

FIG. 8 is a diagram showing the allocation process of FIG. 7 in detail. FIG. 8 also shows transition during the groupwise allocation and the allocation result after the groupwise allocation. This groupwise allocation shows the result of allocation of the source in FIG. 7 by group in order of priority (in order of delivery time, or for the same delivery time, in ascending order of quantity) for each group of A, B and C (groups A, B and C) for the parts indicated by arrows “→” pointing toward the right.

Furthermore, in case of group C, the allocation is executed in order of delivery time, in order of order date and in ascending order of quantity.

In FIG. 8, “•” marked above the quantities of the current stock and the scheduled stock indicates that the stock has been allocated. Principally, the stock scheduled for the corresponding week is allocated first. Then, if the quantity is short for allocating to all of the demand, stock for the previous week and/or the current stock is allocated, in accordance with arrows “←” pointing toward the left. If the quantity is still short, stock for the next week the following week, the following following week, or the like is allocated. In the latter case, there is a possibility that delivery date will be delayed.

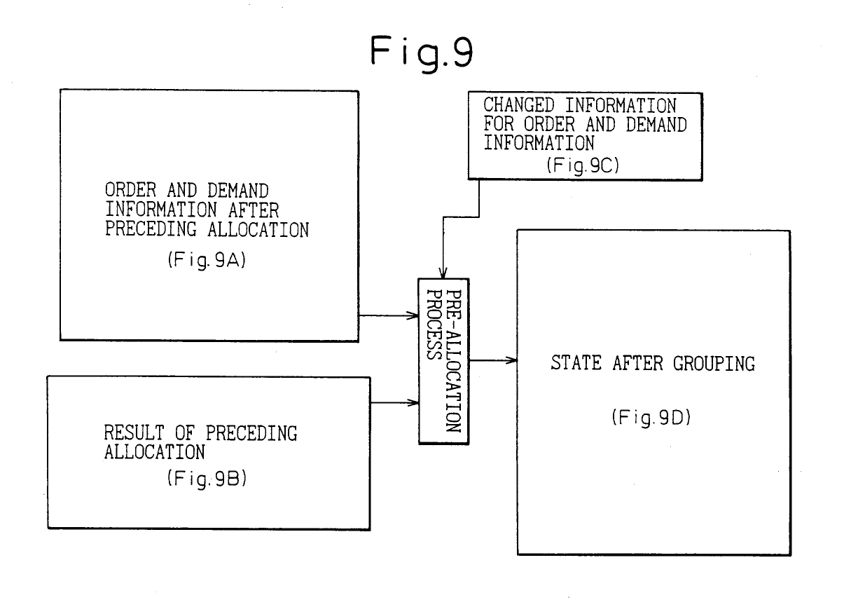

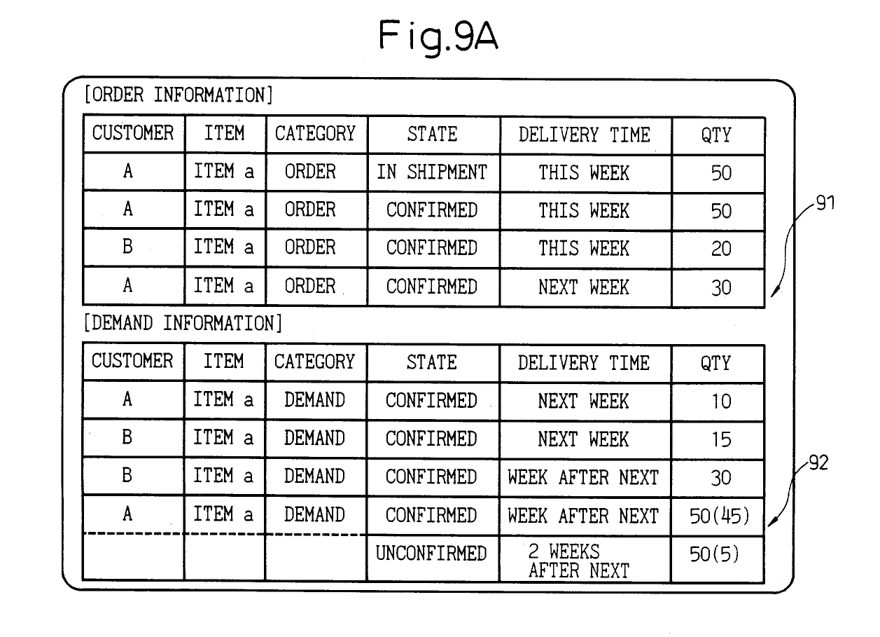

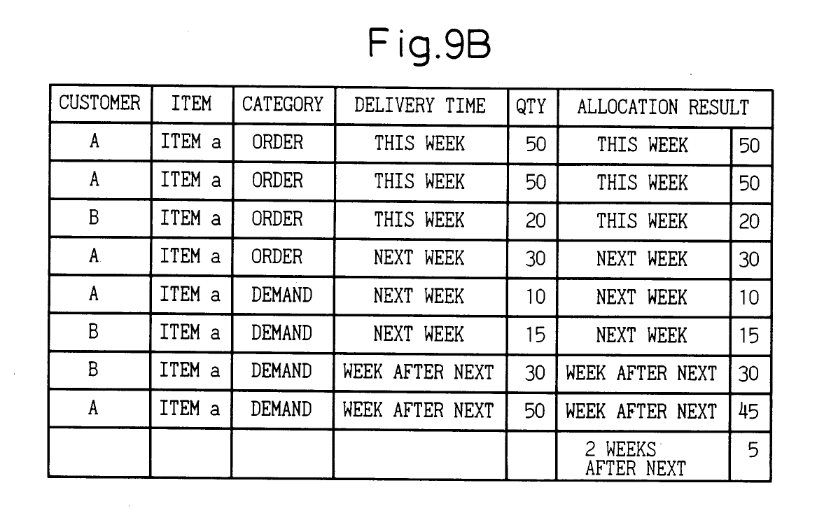

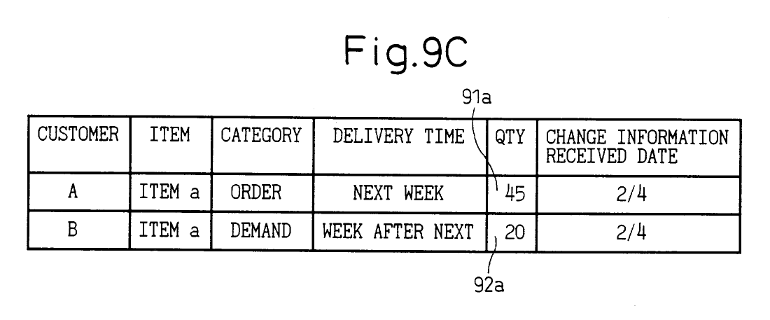

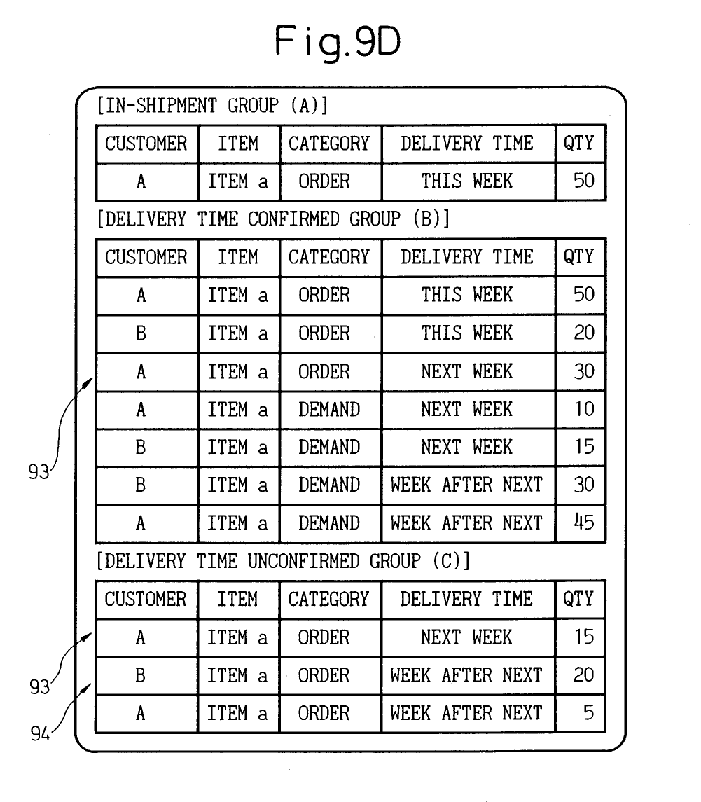

FIGS. 9 and 9A to 9D are diagrams showing the pre-allocation process in which the order/demand information input after the preceding allocation process shown in FIG. 7 are classified by group based on the preceding allocation result shown in FIG. 7 and the order/demand addition/change information. The pre-allocation process shown in FIG. 9 is carried out in the presence of the preceding allocation result. The order/demand addition/change information in the upper right part of FIG. 9, namely in FIG. 9C, shows an example in which the quantity in the order information is changed from 30 to 45 as indicated by arrow 91a from the order/demand information after the preceding allocation shown in the upper left part of FIG. 9, namely in FIG. 9A and the new demand information is added as quantity 20.

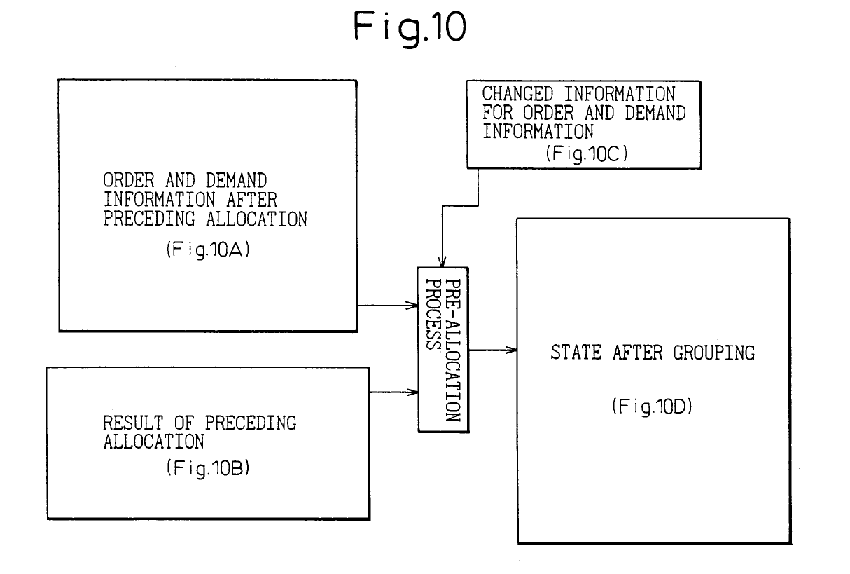

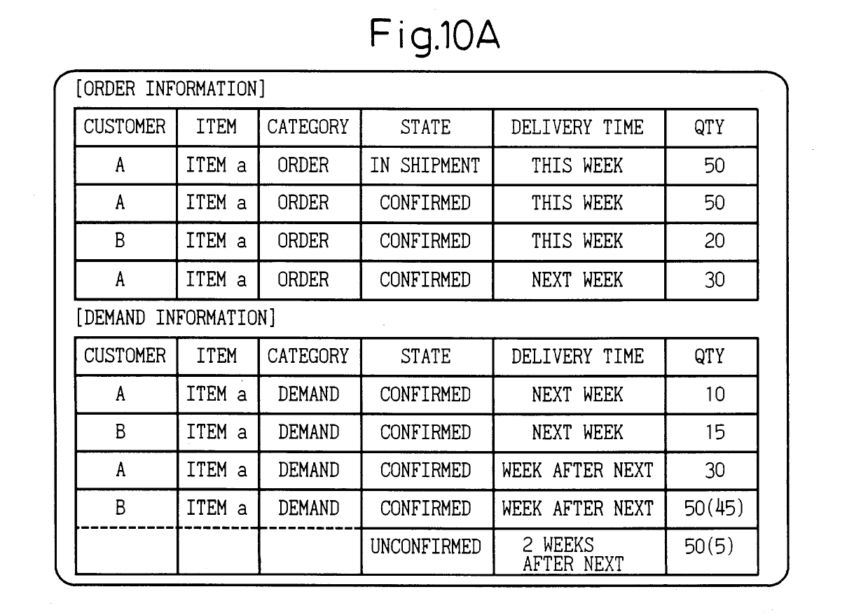

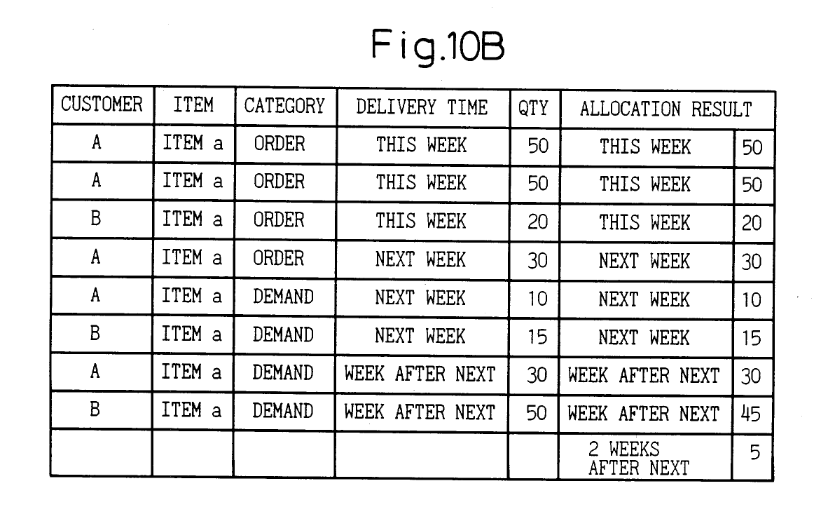

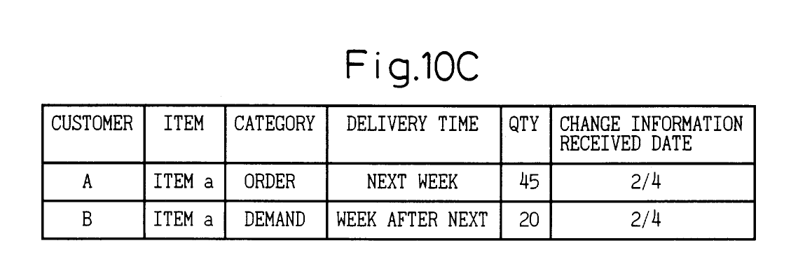

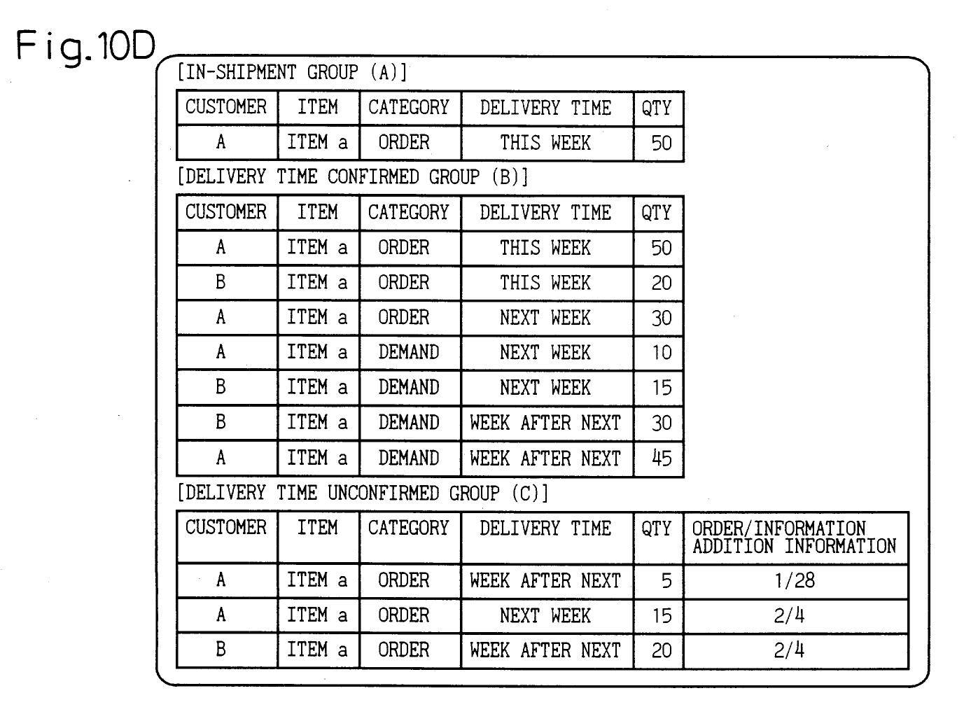

FIGS. 10, and 10A to 10D are diagrams showing the result of the sorting process carried out according to the order received date only for the group C after the pre-allocation process in the groupwise classification shown in FIG. 9.

The lower right part of FIG. 10, namely Fig. 10D shows the result of the grouping process. In view of the fact that, out of the 45 units in the ordered quantity 91a in the upper right part of FIG. 9, namely in FIG. 9C, 30 units of the ordered quantity 91 are confirmed and included in the delivery time confirmed group B (step S29 in FIG. 4 described above), and 15 units are unconfirmed and included in the delivery time unconfirmed group C (step S30 in FIG. 4 described above) in the upper left part of FIG. 9 namely in FIG. 9A. The addition information (quantity 20) 92a in the upper right part of FIG. 9, namely in FIG. 9C, on the other hand, is included in neither the order/demand information after the preceding allocation in FIG. 9A nor the preceding allocation result shown in the lower left part of FIG. 9, namely in FIG. 9B. As indicated by 94 in the lower right part of FIG. 9, namely in FIG. 9D, therefore, all of the 20 units constitute the delivery time unconfirmed group C.

As described above, the change information for the order information 91a and the addition information for the demand information 92a shown in FIG. 9C which may be input are sorted into the corresponding groups as indicated by 93 in FIG. 9D, thereby reflecting the order information or the demand information (See the flowcharts of FIGS. 3 and 4).

The order information and the demand information (including the change information), after being sorted and allocated by group, are reallocated by the ordered date. In this way, the allocation result can be generated. Next, the allocation process according to the invention will be explained in detail with reference to flowcharts.

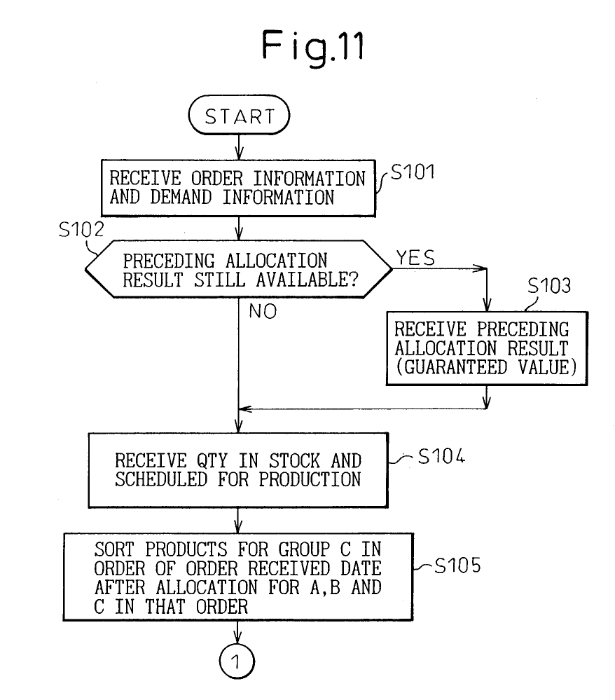

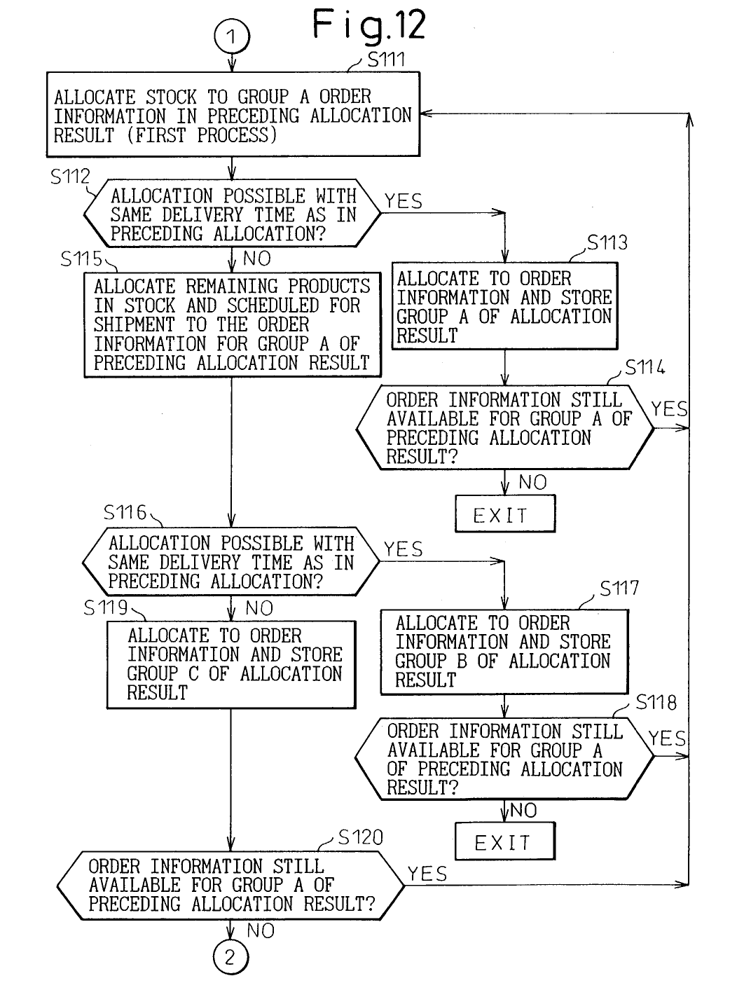

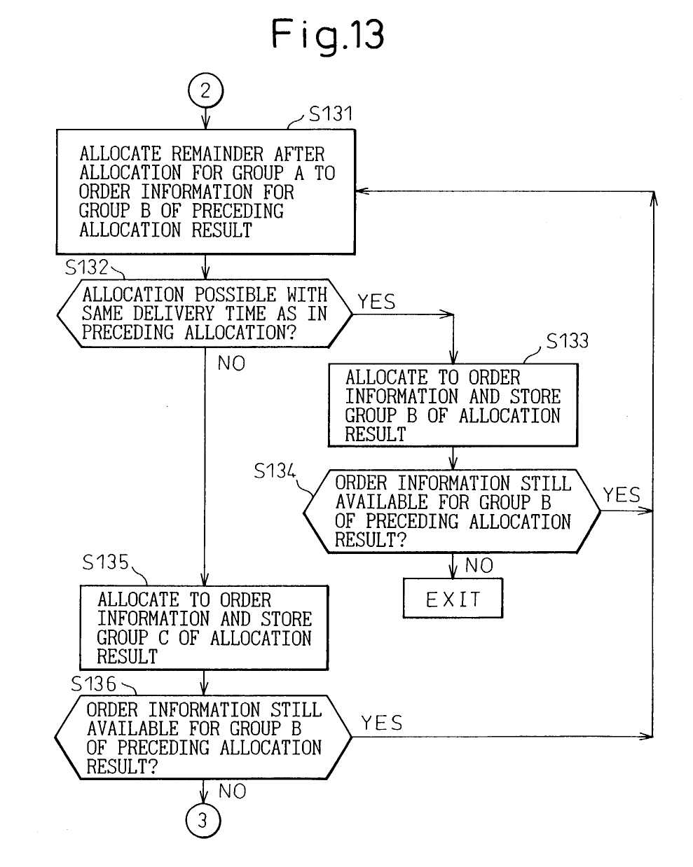

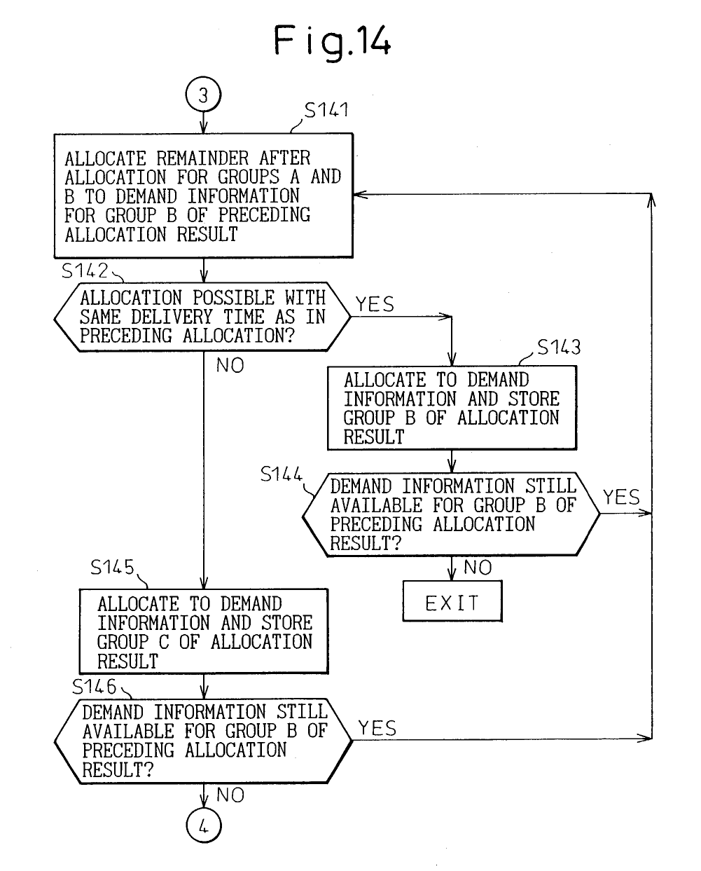

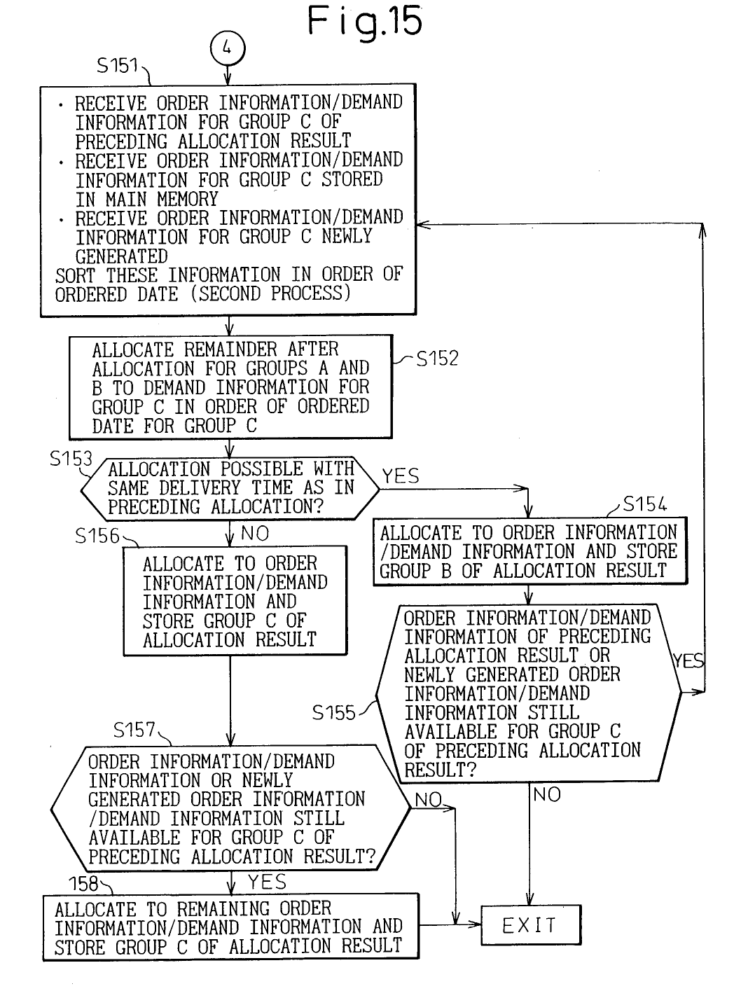

FIGS. 11 to 15 are flowcharts showing the allocation process according to the invention. FIG. 11 is a flowchart for the pre-allocation process, FIG. 12 is a flowchart for the first allocation process for group A, FIG. 13 is a flowchart for the first allocation process for group B, FIG. 14 is a flowchart for the first allocation process for group C, and FIG. 15 is a flowchart for the second allocation (reallocation) process for group C.

In FIG. 11, the order information and the demand information are received in step S101. In step S102, it is determined whether the preceding allocation result is available or not, and in the case where the answer is YES, the process proceeds to step S103 for receiving the preceding allocation result. In the case where the answer is NO in step S102, on the other hand, the process proceeds to step S104 to receive the quantity of products in stock and the quantity of products scheduled to receive from the manufacturing factory. After being allocated to groups A, B and C in that order in step S105, the products for group C are sorted in order of the ordered date (in order of receiving). The ordered date is defined to include the hour, minutes and seconds as well as the year, month and day.

In step S111 of FIG. 12, the stock is allocated to the order information for group A in the preceding allocation result. Step S112 determines whether the allocation with the same delivery time as in the preceding allocation is possible or not. In the case where the answer is YES, the process proceeds to step S113, in which group A in the allocation result is allocated to the order information and stored in the main memory. Then, step S114 determines whether the order information for group A in the preceding allocation result is still available or not. In the case where the answer is YES, the process is returned to step S111, while in the case where the answer is NO, the routine is ended.

In the case where the answer in step S112 is NO, the process proceeds to step S115, in which the quantity of the stock remaining after subtraction in the process of step S111 and the quantity of the products scheduled to be delivered from the manufacturing factory are allocated to the order information for group A in the preceding allocation result.

In step S116, it is determined whether the allocation is possible or not with the same delivery time as in the preceding allocation, and in the case where the answer is YES, the process proceeds to step S117, in which the group B in the allocation result is allocated to the order information and stored in the main memory. Then, step S118 determines whether the order information for group A in the preceding allocation result is still available or not, and in the case where the answer is YES, the process returns to step Sill, while the routine is ended in the case where the answer is NO.

In the case where the answer in step S116 is NO, the process proceeds to step S119, in which the group C in the allocation result is allocated to the order information and stored in the main memory. Next, step S120 determines whether the order information for group A in the preceding allocation result is still available or not, and in the case where the answer is YES, the process returns to step S111, while the process proceeds to step S131 in the case where the determination is NO.

As described above, in steps Sill to S120, the group A is allocated first using the stock (step Sill), and the group formed by the allocation is designated as group A (step S113), while the group A failed in allocation is allocated with the remaining stock and the products scheduled to be delivered from the manufacturing factory (step S115). Then, the group A successfully allocated is set as group B (step S117), and the group A not allocated is set as group C (step S119).

In step S131 of FIG. 13, the quantity of the products in stock and scheduled to be delivered from the manufacturing factory less the quantity subtracted for allocation to group A in steps Sill to S120 is allocated to the order information for group B in the preceding allocation result.

Step S132 determines whether the allocation with the same delivery time as in the preceding allocation is possible or not. In the case where the determination is YES, the process proceeds to step S133 in which the group B in the allocation result is allocated to the order information and stored in the main memory. It is then determined in step S134 whether the order information for group B in the preceding allocation result is still available or not, and in the case where the answer is YES, the process returns to step S131, while the routine is ended in the case where the answer is NO.

In the case where the determination in step S132 is NO, the process proceeds to step S135, in which the group C in the allocation result is allocated to the order information and stored in the main memory. Then, step S136 determines whether the order information for group B in the preceding allocation result is still available or not. In the case where the answer is YES, the process returns to step S131, while the process proceeds to step S141 in the case where the answer is NO.

As described above, in steps S131 to S136, the stock left after allocation to group A and the products scheduled to be delivered from the manufacturing factory are allocated to the group B for the order information (step S131). The group B successfully allocated is set as group B (step S133), while the group B not allocated is set as group C (step S135).

In step S141 of FIG. 14, the quantity of the products in stock and scheduled to be delivered from the manufacturing factory less the quantity subtracted by allocation to groups A and B in steps S111 to S136 is allocated to the demand information for group B in the preceding allocation result.

Step S142 determines whether the allocation with the same delivery time as in the preceding allocation is possible or not. In the case where the answer is YES, the process proceeds to step S143 in which the group B in the allocation result is allocated to the demand information and stored in the main memory. Step S144 determines whether the demand information for group B in the preceding allocation result is still available or not. In the case where the answer is YES, the process returns to step S141, while in the case where the answer is NO, the routine is ended.

In the case where the determination in step S142 is NO, the process proceeds to step S145, in which the group C in the allocation result is allocated to the demand information and stored in the main memory. Then, step S146 determines whether the demand information for group B in the preceding allocation result is still available or not. In the case where this determination is YES, the process returns to step S141, while in the case where the determination is NO, the process proceeds to step S151.

As described above, in steps S141 to S146, the stock remaining after allocation to groups A and B and the products scheduled to be delivered from the manufacturing factory are allocated to the group B for the demand information (step S141). Then, the group B successfully allocated is set as group B (step S143), and the group B failed in allocation is set as group C (step S145).

Finally, the reallocation process, i.e. the second allocation process for group C will be explained below with reference to FIG. 15.

In step S151 of FIG. 15, the order information and the demand information for group C in the preceding allocation result are received, the order information and the demand information for group C stored in the main memory are received, and the order information and the demand information for group C newly generated are also received. All of this information is sorted in order of the ordered date.

In step S152, based on the result of the sorting in step S151, the quantity of the stock and the quantity of the products scheduled to be delivered from the manufacturing factory, less the amount subtracted in the allocation for groups A and B in steps S111 to S146 is allocated to the demand information for group C in the preceding allocation result in order of ordered date for group C.

In step S153, it is determined whether the allocation with the same delivery time as in the preceding allocation is possible or not. In the case where the answer is YES, the process proceeds to step S154 in which the group B in the allocation result is allocated to the order information and the demand information and stored in the main memory. Then, step S155 determines whether the order information and the demand information for group C in the preceding allocation result or the order information and the demand information for group C newly generated are still available or not. In the case where this determination is YES, the process returns to step S151, while in the case where the determination is NO, the routine is ended.

In the case where the determination in step S153 is NO, the process proceeds to step S156, in which the group C already allocated is allocated to the order information and the demand information and stored in the main memory. Then, step S157 determines whether the order information and the demand information for group C in the preceding allocation result or the order information and the demand information for group C newly generated are still available or not. In the case where this determination is YES, the process returns to step S158, while in the case where the determination is NO, the routine is ended.

In step S158, the group C already allocated with the result is allocated to the remaining order information and the remaining demand information for group C and stored in the main memory.

In this way, in steps S151 to S158, the stock remaining after allocation to groups A and B and the products scheduled to be delivered from the manufacturing factory are allocated to group C for the order information and the demand information (step S152), the group C successfully allocated is set as group B (step S154), and the group C not allocated is set as group C (steps S156 and S158).

As the result of the aforementioned process, with regard to the shipment demand for the in-shipment group A extracted from the demand information and the order information, the shipment demand for group B with the delivery time thereof confirmed and the shipment demand for group C with the delivery time thereof not confirmed, the products to be shipped in each of the in-shipment group A, the group B with the delivery time thereof confirmed and the group C with the delivery time thereof not confirmed, in that order, are allocated in order of priority (in order of delivery time, or for the same delivery time, in ascending order of quantity, for example). The shipped products thus allocated are then reallocated based on the ordered date (in order of receiving). By thus obtaining the last allocation result, it is possible to eliminate the conventional unbalanced allocation process in order of a specific event such as generation of order information or delivery time, while at the same time preventing the allocation for a customer from whom an order is received earlier from being delayed behind the allocation for another customer from whom an order is received later.

This embodiment represents the case of three groups including the in-shipment group A, the delivery time confirmed group B and the delivery time unconfirmed group C. Nevertheless, a plurality of groups more than three may be involved. Also, the customers may be grouped not into the in-shipment group, the delivery time confirmed group and the delivery time unconfirmed group, but into groups according to the degree of importance of the customer, the vendor characteristic (availability) of a product item or other events relating to the customer or the product.

It will thus be understood from the foregoing description that, according to the invention, the allocation of shipped products for orders exceeding a predetermined quantity presented beforehand is managed on first-come-first-served basis. Thus, the customer services can be maintained by preventing the allocation for a customer from whom an order is received earlier from being delayed behind the allocation for another customer from whom an order is received later.

What is claimed is:

1. A program used for executing a shipped product allocating method, wherein the shipped products are ordered to be shipped on the delivery date desired by each customer, based on products in stock and products to be delivered from factories:
wherein said program enables a computer to perform method steps, said method steps comprising:
inputting the state of a plurality of demand information and a plurality of order information on shipped products;
classifying said information into a plurality of allocation groups;
sorting a predetermined one of said groups in order of receiving said demand information or said order information;
allocating said shipped products belonging to a given group in a predetermined order of priority; and
reallocating said shipped products in order of receiving said demand information or said order information.

2. A shipped product allocation program according to claim 1, wherein a plurality of said groups include at least an in-shipment group, at least a delivery time confirmed group and at least a delivery time unconfirmed group.

3. A shipped product allocation program according to claim 1, wherein said shipped products belonging to a given group are allocated in order of a selected one of delivery time and quantity.

4. A shipped product allocation program according to claim 2, wherein said shipped products belonging to a given group are allocated in order of a selected one of delivery time and quantity.

5. A shipped product allocating method, wherein the shipped products are ordered to be shipped on the delivery date desired by each customer, based on products in stock and products to be delivered from factories:
wherein said method using a computer comprises the steps of:
inputting the state of a plurality of demand information and a plurality of order information on shipped products;
classifying said information into a plurality of allocation groups;
sorting a predetermined one of said groups in order of receiving said demand information or said order information;
allocating said shipped products belonging to a given group in a predetermined order of priority; and
reallocating said shipped products in order of receiving said demand information or said order information.

6. A shipped product allocation method according to claim 5, wherein a plurality of said groups include at least an in-shipment group, at least a delivery time confirmed group and at least a delivery time unconfirmed group.

7. A shipped product allocation method according to claim 5, wherein said shipped products belonging to a given group are allocated in order of selected one of delivery time and quantity.

8. A shipped product allocation method according to claim 6, wherein said shipped products belonging to a given group are allocated in order of selected one of delivery time and quantity.

9. A shipped product allocating system, wherein the shipped products are ordered to be shipped on the delivery date desired by each customer, based on products in stock and products to be delivered from factories, wherein said system comprising:
means for inputting the state of a plurality of demand information and a plurality of order information on shipped products;
means for classifying said information into a plurality of allocation groups;
means for sorting a predetermined one of said groups in order of receiving said demand information or said order information;
means for allocating said shipped products belonging to a given group in a predetermined order of priority; and
means for reallocating said shipped products in order of receiving said demand information or said order information.

10. A shipped product allocation system according to claim 9, wherein said plurality of the groups include at least an in-shipment group, at least a delivery time confirmed group and at least a delivery time unconfirmed group.

11. A shipped product allocation system according to claim 9, said shipped products belonging to a given group are allocated in order of a selected one of delivery time and quantity.

12. A shipped product allocation system according to claim 10, said shipped products belonging to a given group are allocated in order of a selected one of delivery time and quantity.
